(19) United States
(12) Patent Application Publication
(10) Pub. No.: US 2009/0200889 A1
(43) Pub. Date: Aug. 13, 2009

(54) Nested Serpentine Winding for an Axial Gap Electric Dynamo Machine

(75) Inventor: Richard Halstead, Rohnert Park, CA (US)

Correspondence Address: EDWARD S. SHERMAN, ESQ., 3554 ROUND BARN BLVD., SUITE 303, SANTA ROSA, CA, 95403, US

(73) Assignee: EMPIRE MAGNETICS INC., Rohnert Park, CA (US)

(21) Appl. No.: 12/367,931

(22) Filed: Feb. 9, 2009

Related U.S. Application Data
(60) Provisional application No. 61/027,370, filed on Feb. 8, 2008.
(60) Provisional application No. 61/027,465, filed on Feb. 10, 2008.

(51) Int. Cl. H02K 3/28

(52) U.S. Cl. 310/208

(57) ABSTRACT

The stator of an axial gap dynamoelectric machine comprises two or more serpentine coil arrays that are formed form a continuous loop of insulated wire. The serpentine coils are deflected in at least some of the tangential components so the place radial segments disposed to generate a Lorenz force with respect to the rotor magnets in a common plane, reducing the gap there between.

### CROSS REFERENCE TO RELATED APPLICATIONS

The present application claims priority to the U.S. Provisional Patent application of the same title that was filed on Feb. 8, 2008, having application Ser. No. 61/027,370, which is incorporated herein by reference.

The present application also claims priority to the U.S. Provision Patent Appl. No. 61/027,465 filed on Feb. 10, 2008, which is incorporated herein by reference.

### BACKGROUND OF INVENTION

The present invention relates to axial gap dynamo electric machines and more particularly, in improvements of the windings thereof.

Axial gap dynamo electric machines deploy stators and rotators that are generally in the shape of parallel and adjacent planar discs, with one of more rotators attached to an axle that passes though the center of each disk.

The stators comprises multiple windings that generally wrap across the radial direction of the disc. A Lorenz force is generated by the interaction with magnets arranged along the periphery of the rotor disc. A more detailed description of this technology can be found in the U.S. Pat. Nos. 4,567,391; 4,578,610; 5,982,069; and 5,744,896, all of which are incorporated herein by reference.

Prior methods axial gap dynamo electric machines (EDM's), that is motors and generators, require a different winding pattern than more conventional radial EDM's. The winding and assembly of the segments adds significantly to the cost of making such EDM's.

Accordingly, it is a general object of the invention to improve the quality and economic viability of large scale axial gap electro-dynamo machines (EDM) for use as generators and motors.

It is also more specifically a first object of the present invention to provide a simpler and more cost effective method of assembling the stators of axial gap dynamoelectric machine for use as generators and motors, and in particular for wind power generation of electricity.

It is a more specific object of the invention to provide a more efficient method winding the stator coils of such generators and motors.

It is an additional objective of the invention to provide a more efficient method of stator assembly for large scale axial gaps EDM's.

It is a further objective of the invention to provide the above benefits at least in part through an improved efficiency through the concentration of the rotor magnetic field with respect to its interaction with the stator structure.

### SUMMARY OF INVENTION

In the present invention, the first object is achieved by providing an axial gap dynamo electric machine, the machine comprising: an axle, at least one rotor disk in rotary co-axle connection to said axle and having at the periphery thereof an array of permanent magnets with each magnetic having an alternating orientation of the poles with respect to the adjacent magnets in the array, a stator disk having disposed co-axially about said axle and supporting two or more electrically energizable planar coil arrays that each comprises at least one serpentine shaped sub-coils, each sub-coil having loop segments with radial segments disposed to generate a Lorenz force with respect to the rotor magnets, with each radial segment joined to the next by a series of alternating inner and outer tangential segments, wherein at least one of the inner and outer tangential segments of at least one serpentine sub-coil are deflected out of a common plan to dispose the radial segments of each serpentine array in a common plane.

The above and other objects, effects, features, and advantages of the present invention will become more apparent from the following description of the embodiments thereof taken in conjunction with the accompanying drawings.

### BRIEF DESCRIPTION OF THE DRAWINGS

FIG. 1A is a cross-sectional elevation through the axis of a EDM according to a first embodiment of the invention.

FIG. 1B is a plan view of the stator coils in FIG. 1A.

FIG. 1C is a cross-section transverse to the winding in the stator coils showing multiple insulated wires therein.

FIG. 2 is perspective view of a planar coil array prior to deformation and interlacing as shown in FIG. 3.

FIG. 3 is a perspective view of two inter-laced planar coil arrays according to one embodiment of the invention.

FIG. 4C is a plan view of a portion of the first serpentine and substantially planar array of FIG. 1A.

FIG. 4A is a radial sectional elevation of a radial portion of a serpentine planar array of FIG. 1B

FIG. 4B is a tangential section elevation of the outer tangential portion of the serpentine planar array of FIGS. 1B and 1C showing the interlaced radial portion of the other serpentine substantially planar array.

FIG. 5A is a plan view of a portion of the stator disk in another embodiment of the invention.

FIG. 5B is an elevation of a portion of an stator disk at section line B-B in FIG. 5A.

### DETAILED DESCRIPTION

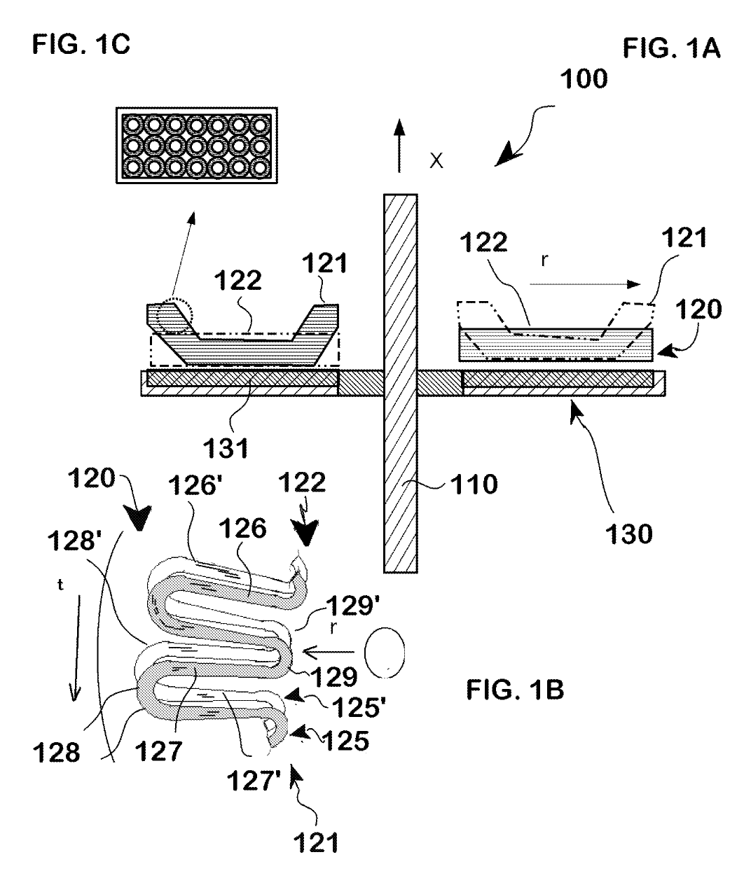

Referring to FIGS. 1-5, wherein like reference numerals refer to like components in the various views, there is illustrated therein a new and improved axial gap EDM, generally denominated 100 herein.

The coordinate system for FIG. 1-5 is non-orthogonal and circular, with the x-direction being the long axis of rotor axle 110, r-direction being the radial direction of the stator disk 120 and rotor disk 130, and the t-direction being tangential to the stator disk 120 and rotor disk 130.

FIG. 1A-C illustrate that primary components of the axial gap EDM 100, having an axle 110 coupled to a rotor disk 130 with permanent magnets 131 radially arrayed at the periphery thereof. Each of the permanent magnets 131 is disposed with an alternating orientation of its poles with respect to the adjacent magnets in the array. It will be appreciated by one familiar with the construction of motors that the stator disk 120 is generated supported or attached to the motor housing and the axle 110 is confined for free rotation of the axle axis by rotary type bearings that are also attached or couple to the motor housing. As the motor housing and bearings are generally conventional in the art, they are omitted from the Figures for simplicity of illustration.

However, in a more preferred embodiments, the outer periphery of the rotor 130 is supported by a magnetic bearing, as for example in the magnetic bearing system disclosed in U.S. Provision Patent Appl. No. 61/027,465 filed on Feb. 10, 2008, which is incorporated herein by reference.

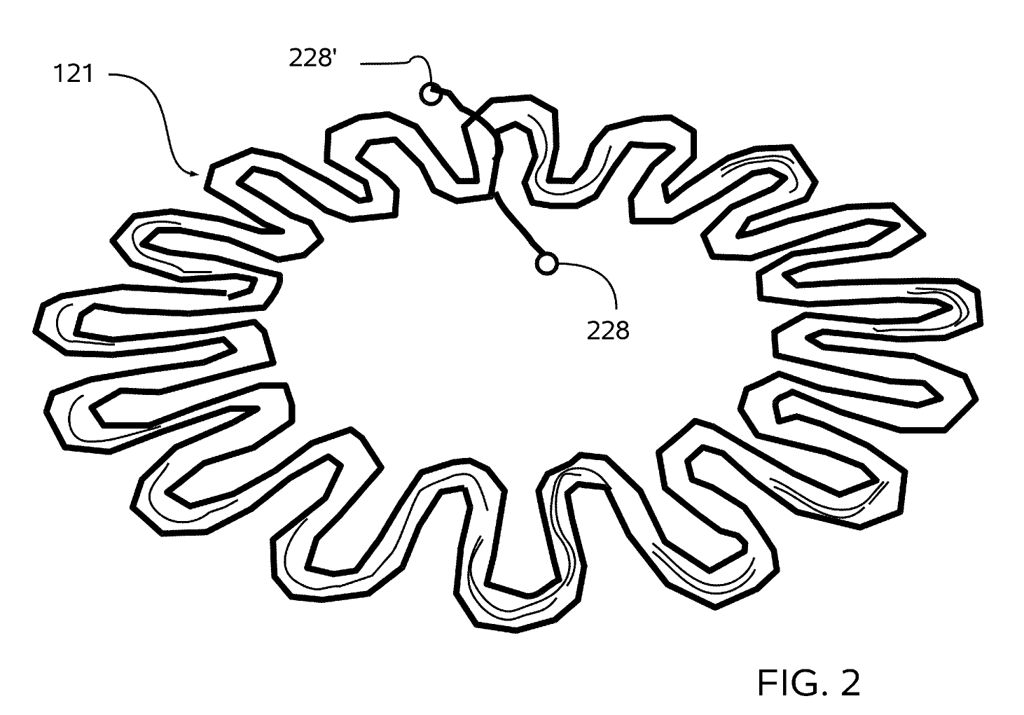

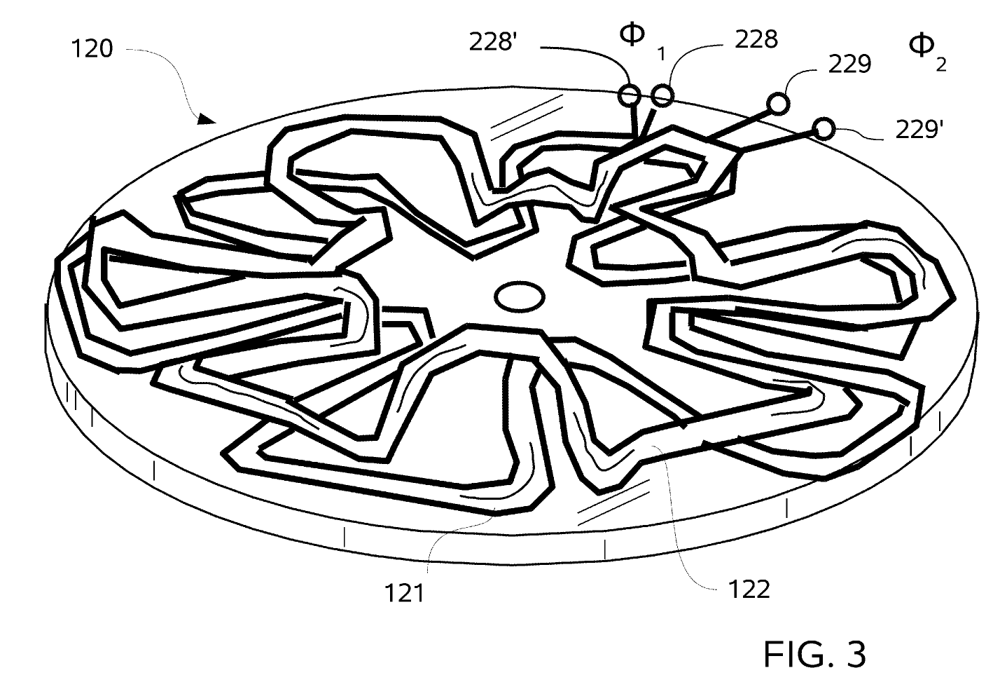

The stator disk 120 has at least two substantially planar serpentine coil arrays 121 and 122 formed thereon, with the radial segments inter-laced. Each serpentine coil arrays 121 and 122 is formed first by winding insulated wire into a generally flat serpentine coil. Such a wound coil 121 is shown in FIG. 2 prior to nesting with a similar serpentine coil, as shown in perspective in FIG. 3. The coil 121 preferably has adjacent terminals 228 and 228′ at the ends of the wire formed into coil 121. The winding is preferably continuous in that the wire makes a full serpentine loop before passing an arbitrary reference point on the wire, or each of the loop segment of the serpentine coil can be wound before forming the wire into the adjacent and then subsequent loop segments. Each serpentine coil arrays 121 and 122 is preferably powered or tapped as a different phase, depending on the EDM's 100 use as motor or generator.

As shown in FIG. 1B, each serpentine coil 121 and 122 has a plurality of loop segments 125 in a radial spoke arrangement akin to flower petals arrange about the axle 110. Each loop segment can be considered as having a pair of radial segments 126 and 127 disposed to generate a Lorenz force with respect to the rotor magnets and a pair of alternating inner and outer tangential segment 128 and 129 joining the radial segments 126 and 127.

The radial segment of 126 and 127 of continuous serpentine coil array 121 are interlaced radially with the same radial segments 126′ and 127′ of continuous serpentine coil array 122 so as to be disposed in a common plane. That is radial segment 127′ (of serpentine coil 122) lies between radial segments 126 and 127 of the other serpentine coil 121. However, at least one of the inner and outer tangential segments of one or the other serpentine must be deformed out of the common plane by bending upward then parallel to the common plane of the radial segments to avoid interference between the tangential segment 128 and 128′ as well as 129 and 129′. This deformation is best illustrated in FIG. 1A, in which the left section is through the mid-section of a loop segment of serpentine coil 121 with the adjacent loop segment being of serpentine coil 122, being shown in a broken line. In contrast, in the right side of axle 110, the section is through the mid-section of loop segment being of serpentine coil 122, with the adjacent loop segment being of serpentine coil 121. It should be appreciated, that the method of forming the serpentine coils from a single length of wire is very efficient, avoiding the need to connect individual loop segment 125, with the placement of radial segments 126/127 of each serpentine coil in the same plane reducing the gap between each serpentine coil and the magnets 131, thus increasing efficiency of the EDM as either a motor or generator.

It should also be appreciated that as each serpentine coil array is formed of a continuous length of insulated wire it can be selectively deformed after winding either individually at each loop segment or together in a common press mold deflected the appropriate segment of one or each serpentine coil array out of a common plane to span at least one of over or under the radial segment of the other serpentine coil array.

FIG. 2 shows the serpentine coil 121 formed of round insulted wire in a perspective view. FIG. 3 shows a second serpentine coil 122, comparable to 121, but deformed and interlaced with coil 121, as shown in FIG. 1 to form a portion of the stator disk 120. The second serpentine coil 122 preferably has adjacent terminals 229 and 229′ at the ends of the wire used to formed the coil 122, as is either powered or tapped at a different phase (φ₂) from the phase of coil 121 (φ₁).

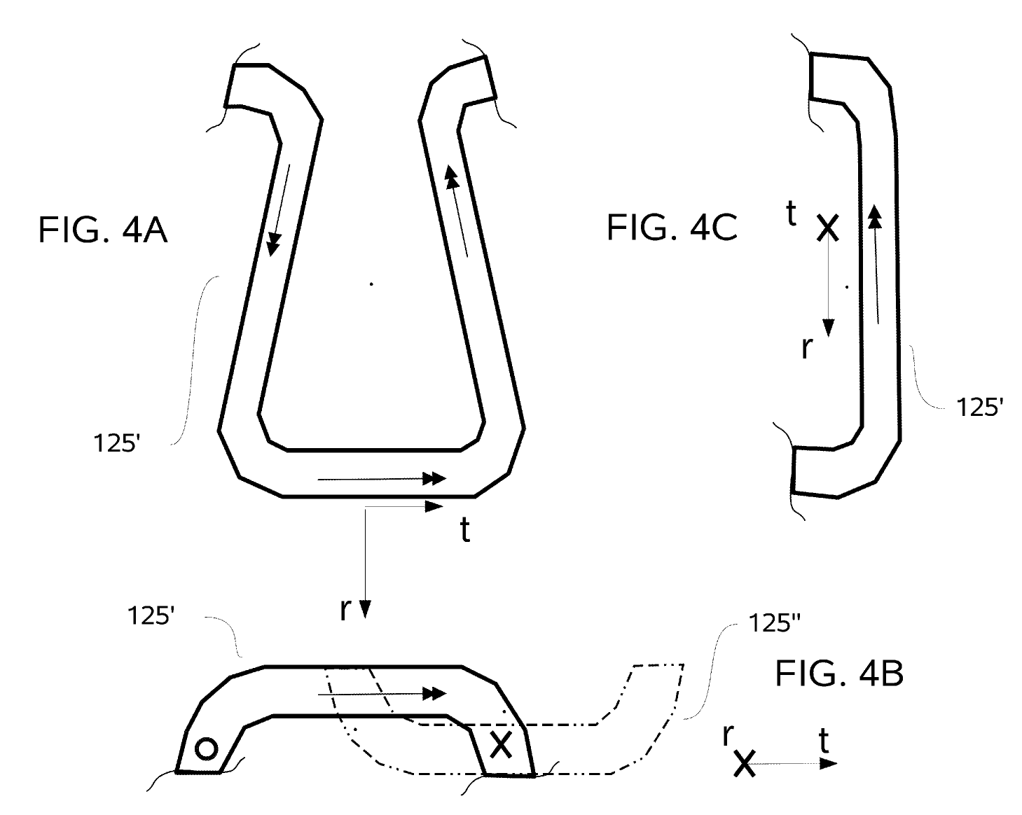

As more fully shown in FIG. 4C, the loop segment 125 has the ends of the radial portion bent upward to clear the tangential and radial portion of the adjacent loop segment 125′, with the arrows indicating the direction of current flow.

Accordingly the nested arrangement of the loop segment of each serpentine sub-coils with tangentially segments bent out of the common plane of the radial windings to maximizes the coil packing for more efficient devices at a small size that also benefit in power from the minimized gap between the stator windings and the rotor magnets.

Based on this disclosure, it should be apparent to one of ordinary skill in the art that different combinations of bends in primarily the tangential portion of each serpentine coil may be used to dispose the radial segments interlaced in a common plane. For examples, the adjacent tangential segments of one coil may be bent up with the adjacent coil tangential segment s bent down. Alternatively, one serpentine coil may have the outer tangential segments bent with the other serpentine coil having the inner tangential coil bent in either the same or opposite direction. Further, additional serpentine coil may be utilized with the radial segments interlaced in a common plane in a similar manner. It should of course be apparent that the EDM 100 can be used as a motor or a generator, although the preferred embodiment of each may different depending the end use application.

It should also be appreciated that although the insulated wires shown in FIG. 1C are circular to form a rectangular bundle, they are optionally of rectangular cross section and may be packed in a rectangular, circular, oblong or a bundle of any shape.

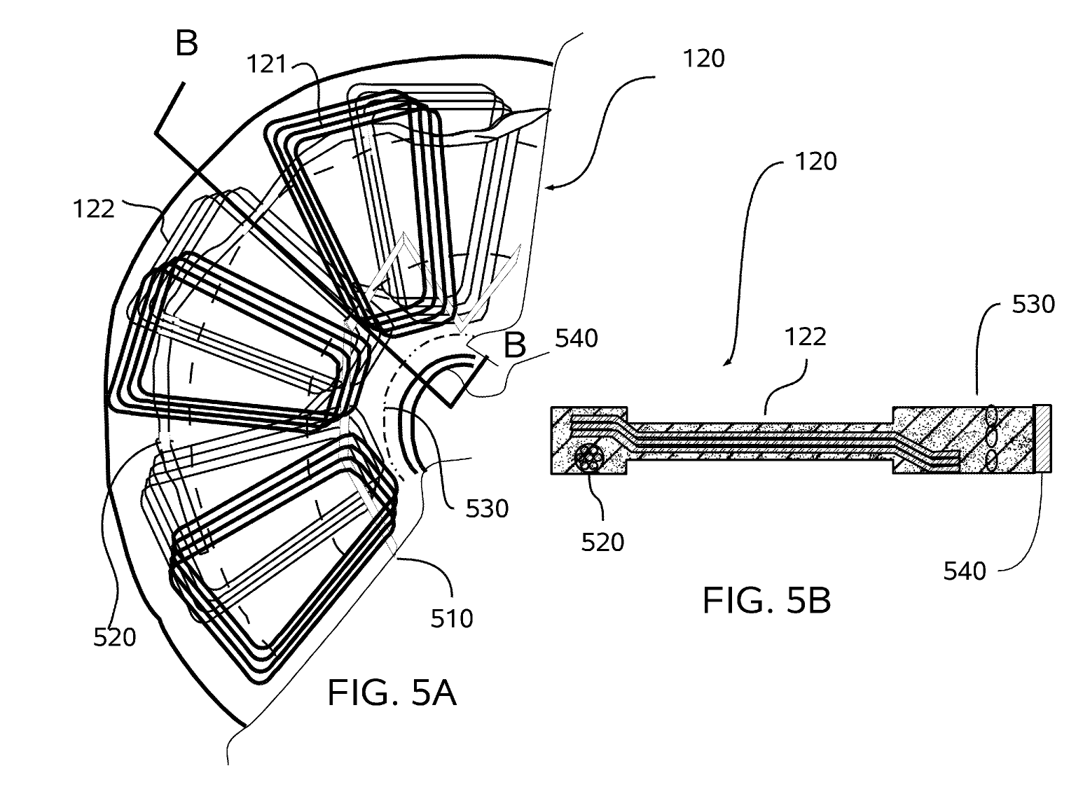

Further, it is also preferable that the serpentine coils are encased in a fiber reinforced cement mixture to form self supporting stator disc 120, as shown in FIG. 5. The fiber cement is a relatively good thermal conductor but electrical insulator that is sturdy and relatively light weight so that it draws heat produced by resistance heating from the coil. Further, the processing of encasing is can be performed in a mold with a top and bottom section such that the closing of the mold deforms the crossing generally tangential segments of the serpentine coils. It should be appreciated in this context that the term tangential is relative, as the portion of the coils between the radial sections are preferably rounded or have at least rounded corners and thus will have a truly tangentially orient segment for only a limited portion of the distance the coil segment between the radial portions.

It is also preferable, as shown in FIG. 5A, when encasing the serpentine coils in the fiber cement that the coils are first bound together, such as by strapping 510, or at least to a common substrate or other element. While the fiber are preferably glass fibers randomly dispersed in the cement, other fibers are possible so long as the cement remains a high dielectric strength insulator or high dielectric strength insulating material, such a organic polymer films, are placed between the serpentine coils 121 and 122. More preferably, long or high aspect ratio chopped fibers are sprinkled on the concrete prior to filling the mold and current. Most preferably, reinforcement is added to the mold, such as continuous fiber cord 520, such a glass fiber bundles, but also polyester fiber cords, as well as expanded metal mesh 530. As shown in FIG. 5B, it is more preferable to include the metal mesh 530 close to the center of the stator disk, and wrap the fiber cord 520 through the outer segments of the loop segments 125 by alternating between the segments in coils 121 and 122. Further, it is most preferable to reinforce the inner edge of the stator disk with a metal ring 540.

Moreover, it is preferably to use a concrete formulation that neither shrinks or expands on curing, and that is preferably also contains toughening additives to prevent cracking, such as initially water soluble polymer or polymer emulsions or latexes. Cracking during curing or setting can also be avoided by minimizing the temperature rise during setting by chilling the mold and/or pre-cooling the liquid components of the concrete mixture.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

1. An axial gap dynamo electric machine, the machine comprising:
a) an axle,
b) at least one rotor disk in rotary co-axle connection to said axle and having at the periphery thereof an array of permanent magnets with each magnetic having an alternating orientation of the poles with respect to the adjacent magnets in the array,
c) a stator disk having disposed co-axially about said axle and supporting two or more continuous serpentine planar coil arrays, each serpentine coil array being formed of a continuous length of insulated wire and comprising in a petal arrangement linked loop elements, each of which comprises;
i) radial segments disposed to generate a Lorenz force with respect to the rotor magnets,
ii) alternating inner and outer tangential segment joining the radial segments,
d) wherein the radial segment of each of the two or more continuous serpentine coil arrays are interlaced radially so as to be disposed in a common plane, wherein at least one of the inner and outer tangential segments of one or the other serpentine coiled arrays is deflected out of the common plane so to span at least one of over or under the radial segment of the other serpentine coil array.

2. An axial gap dynamo electric machine according to claim 1 wherein both the inner and outer tangential segments of one or the other serpentine coiled arrays is deflected out of the common plane so to span at least one of over or under the radial segment of the other serpentine coil array.

3. An axial gap dynamo electric machine according to claim 1 wherein both the inner and outer tangential segments of each serpentine coiled array is deflected out of the common plane so to span at least one of over or under the radial segment of the other serpentine coil array.

4. An axial gap dynamo electric machine according to claim 1 wherein at least one of the inner and outer tangential segments of each serpentine coiled array is deflected out of the common plane so to span at least one of over or under the radial segment of the other serpentine coil array.

5. An axial gap dynamo electric machine according to claim 1 wherein each serpentine coiled array is at least one of powered or tapped at different phase from at least one other serpentine coiled array.

6. An axial gap dynamo electric machine, the machine comprising:
a) an axle,
b) at least one rotor disk in rotary co-axle connection to said axle and having at the periphery thereof an array of permanent magnets with each magnetic having an alternating orientation of the poles with respect to the adjacent magnets in the array,
c) a stator disk having disposed co-axially about said axle and supporting two or more continuous serpentine planar coil arrays, each serpentine coil array being formed of a continuous length of insulated wire and comprising in a petal arrangement linked loop elements, each of which comprises;
i) radial segments disposed to generate a Lorenz force with respect to the rotor magnets,
ii) alternating inner and outer tangential segment joining the radial segments,
d) wherein the radial segment of each of the two or more continuous serpentine coil arrays are interlaced radially and encased in a fiber reinforced cement mixture to form a self supporting stator disc.

7. An axial gap dynamo electric machine according to claim 6 wherein the radially interlaced segments are disposed in a common plane, wherein at least one of the inner and outer tangential segments of one or the other serpentine coiled arrays is deflected out of the common plane so to span at least one of over or under the radial segment of the other serpentine coil array.

8. An axial gap dynamo electric machine according to claim 6 wherein at least one of the serpentine coil arrays is formed by wrapping the continuous length of insulated wire in a complete loop around the stator.

9. An axial gap dynamo electric machine according to claim 6 wherein at least one of the serpentine coil arrays is formed by wrapping the continuous length of insulated wire into a plurality of looped segments have a two tangential and two radial segments, wherein each segment is wrapped before wrapping the adjacent segment on the stator.
